(19) United States
(12) Patent Application Publication
(10) Pub. No.: US 2024/0155743 A1
(43) Pub. Date: May 9, 2024

(54) INDUCTION HEATING DEVICE

(71) Applicants: NGK INSULATORS, LTD., Nagoya-Shi (JP); NATIONAL UNIVERSITY CORPORATION OKAYAMA UNIVERSITY, Okayama-Shi (JP)

(72) Inventors: Kazuhiro UMETANI, Okayama-Shi (JP); Shota KAWAHARA, Okayama-Shi (JP); Daiki MIYAKE, Nagoya-Shi (JP); Masataka ISHIHARA, Okayama-Shi (JP); Eiji HIRAKI, Okayama-Shi (JP); Shuichi ICHIKAWA, Nagoya-Shi (JP); Yukio MIYAIRI, Nagoya-Shi (JP); Masaaki MASUDA, Nagoya-Shi (JP); Takuya ISHIHARA, Tsushima-Shi (JP)

(73) Assignees: NGK INSULATORS, LTD., Nagoya-Shi (JP); NATIONAL UNIVERSITY CORPORATION OKAYAMA UNIVERSITY, Okayama-Shi (JP)

(21) Appl. No.: 18/497,204

(22) Filed: Oct. 30, 2023

(30) Foreign Application Priority Data
Nov. 4, 2022 (JP) 2022-177661

(51) Int. Cl. H05B 6/36; H05B 6/10

(52) U.S. Cl. CPC H05B 6/365; H05B 6/101; H05B 2206/022

(57) ABSTRACT

An induction heating device according to the present invention includes: an induction heating coil 10 with a conductor 100 wound around a predetermined axis line AL; a member 11 including at least one soft magnetic material 110, the at least one soft magnetic material 110 being disposed at or on an outer side of each of axial end portions 102 of the induction heating coil 10 in an extending direction of the axis line AL; and a heating object 2 disposed on an inner side of the induction heating coil 10 and the member 11, the heating object 2 being configured to be heatable by induction heating using a magnetic flux from the induction heating coil 10.

### FIELD OF THE INVENTION

The present invention relates to an induction heating device.

### BACKGROUND OF THE INVENTION

For example, as shown in Non-Patent Literature 1 below, induction heating is known to heat a heating object by electromagnetic induction. The induction heating is performed by placing an induction heating coil near a heating object containing magnetic and/or conductive materials and generating a magnetic field near the induction heating coil.

The induction heating coil can be formed by winding a conductor, such as a copper pipe and a rectangular wire, around a predetermined axis. For example, when heating a pillar shaped heating object, the induction heating coil can be placed around the periphery of the heating object. A magnetic field can be generated by passing an electric current through the induction heating coil. The current flowing through the induction heating coil can be a large current obtained by amplifying alternating a current from a high-frequency inverter with a transformer. The induction heating is particularly useful for heating materials with poor thermal conductivity and for heating objects under conditions where thermal contact is not easy, because the induction heating can heat the heating objects without any contact.

### CITATION LIST

### Non-Patent Literature

[Non-Patent Literature 1] JAPAN ELECTRO-HEAT CENTER (ed.), “Newly Revised Version: Electro-heat Handbook”, Ohmsha, Ltd., Apr. 10, 2019 (p. 263)

### SUMMARY OF THE INVENTION

When the heating object is placed in the induction heating coil as described above, the magnetic flux tends to concentrate on the outer peripheral portion of the heating object close to the induction heating coil, and a temperature deviation tends to occur between the outer peripheral portion and the central portion of the heating object.

The present invention was made to solve the above problems. An object of the present invention is to provide an induction heating device which can reduce the temperature deviation between the outer peripheral portion and the central portion of the heating object.

### Aspect 1.

In an embodiment, the present invention relates to an induction heating device, comprising: an induction heating coil with a conductor wound around a predetermined axis line; a member comprising at least one soft magnetic material, the at least one soft magnetic material being disposed at or on an outer side of each of axial end portions of the induction heating coil in an extending direction of the axis line; and a heating object disposed on an inner side of the induction heating coil and the member, the heating object being configured to be heatable by induction heating using a magnetic flux from the induction heating coil.

### Aspect 2.

The present invention may relate to the induction heating device according to Aspect 1, wherein the heating object forms a flow path for a fluid flowing in the extending direction of the axis line.

### Aspect 3

The present invention may relate to the induction heating device according to Aspect 2, wherein the member has a plate-shaped soft magnetic material having a plurality of through holes to form a flow path together with the heating object.

### Aspect 4.

The present invention may relate to the induction heating device according to Aspect 3, wherein a maximum width of the through hole in a plane orthogonal to the axis line is 85% or less of a length of the induction heating coil in the extending direction of the axis line.

### Aspect 5.

The present invention may relate to the induction heating device according to any one of Aspects 1 to 4, wherein the induction heating coil has opening portions on both sides in the extending direction of the axis line, and wherein the member is disposed so as to cover at least a part of at least one of the opening portions.

### Aspect 6.

The present invention may relate to the induction heating device according to any one of Aspects 1 to 5, wherein the induction heating coil has opening portions on both sides in the extending direction of the axis line, and wherein the member comprises: a first member covering one opening portion of the induction heating coil; and a second member covering other opening portion of the induction heating coil.

### Aspect 7.

The present invention may relate to the induction heating device according to any one of Aspects 1 to 6, further comprising a back wall disposed to cover at least a part of a back portion of the induction heating coil, the back wall being made of a soft magnetic material.

### Aspect 8.

The invention may relate to the induction heating device according to Aspect 7, wherein the back wall is connected to the member at an end portion of the induction heating coil.

### Aspect 9.

The present invention may relate to the induction heating device according to any one of Aspects 1 to 8, wherein the induction heating coil has opening portions on both sides in the extending direction of the axis line, and wherein the member comprises a plurality of rod-shaped soft magnetic materials each extending from an outer edge of each of the opening portions to a central portion.

### Aspect 10.

The present invention may relate to the induction heating device according to Aspect 9, wherein each of the rod-shaped soft magnetic materials has an outer end located on the outer edge side of each of the opening portions, and an inner end located on the central portion side of each of the opening portion, and wherein a cross-sectional area of the outer end is larger than that of the inner end.

### Aspect 11.

The present invention may relate to the induction heating device according to Aspect 9, wherein a maximum distance between the rod-shaped soft magnetic materials is 85% or less of the length of the induction heating coil in the extending direction of the axis line.

### Aspect 12.

The present invention may relate to the induction heating device according to any one of Aspects 1 to 11, wherein the soft magnetic material has a relative magnetic permeability of 80 or more.

### Aspect 13.

The present invention may relate to the induction heating device according to any one of Aspects 1 to 12, wherein the soft magnetic material has a resistivity of 10 Ωcm or more.

### Aspect 14.

The present invention may relate to the induction heating device according to any one of Aspects 1 to 13, wherein the soft magnetic material has a Curie point of 250° C. or more.

### Aspect 15.

The present invention may relate to the induction heating device according to any one of Aspects 1 to 14, wherein the soft magnetic material has a plurality of soft magnetic material blocks arranged side by side in a direction orthogonal to the axis line, and wherein the member further comprises a support material for supporting the plurality of soft magnetic material blocks.

### Aspect 16.

The present invention may relate to the induction heating device according to any one of Aspects 1 to 15, wherein a total cross-sectional area Sₘ of the soft magnetic material is set to satisfy {(μ_{c}NIS_{c})/L_{c}Sₘ}<Bₘₛ, wherein μ_{c} (H/m) is a magnetic permeability of the heating object, N is a number of turns of the induction heating coil, I (A) is a current flowing through the induction heating coil, S_{c} (m²) is a cross-sectional area of the heating object, L_{c} (m) is a length of the heating object in the extending direction of the axis line, Sₘ (m²) is a total cross-sectional area of the soft magnetic material included in the member, and Bₘₛ (T) is a saturation magnetic flux density of the soft magnetic material.

### Aspect 17.

The induction heating device may relate to the induction heating device according to any one of Aspects 1 to 16, wherein the heating object is a honeycomb structure having a honeycomb structure portion comprising: an outer peripheral wall and a partition wall disposed on an inner side of the outer peripheral wall, the partition wall defining a plurality of cells, each of the cells extending from one end face to other end face to form a flow path.

### Aspect 18.

The present invention may relate to the induction heating device according to Aspect 17, wherein a part or the whole of the honeycomb structure comprises a magnetic material.

### Aspect 19.

The present invention may relate to the induction heating device according to any one of Aspects 1 to 18, further comprising a power supply circuit, the power supply circuit comprising: a direct-current power supply; an inverter for converting direct-current power from the direct-current power supply to alternating-current power; and a transformer connected to the inverter and the induction heating coil, the transformer amplifying a current of the alternating-current power of the inverter and supplying it to the induction heating coil.

According to one embodiment of the induction heating device of the present invention, it is possible to reduce the temperature deviation between the outer peripheral portion and the central portion of the heating object.

### BRIEF DESCRIPTION OF THE DRAWINGS

FIG. 1 is a perspective sectional view showing an induction heating device according to an embodiment of the present invention;

FIG. 2 is an enlarged perspective cross-sectional view of the region II in FIG. 1;

FIG. 3 is a circuit diagram showing an example of the power supply circuit in FIG. 1;

FIG. 4 is a perspective view showing a first variation of the soft magnetic material in FIG. 1;

FIG. 5 is a perspective cross-sectional view showing a second variation of the soft magnetic material in FIG. 1;

FIG. 6 is a perspective cross-sectional view showing a third variation of the soft magnetic material in FIG. 1;

FIG. 7 is a cross-sectional view of the induction heating device in FIG. 6;

FIG. 8 is a plane view showing the induction heating device in FIG. 7;

FIG. 9 is a circuit diagram showing a magnetic circuit through which the magnetic flux φ in FIG. 7 flows;

FIG. 10 is a graph showing a relationship between a ratio of a maximum distance between soft magnetic materials to a length of an induction heating coil and uneven heating of a heating object;

FIG. 11 is a perspective view showing the soft magnetic material in FIG. 7; and

FIG. 12 is a perspective view showing an example of the heating object in FIG. 1.

### DETAILED DESCRIPTION OF THE INVENTION

Hereinafter, embodiments for carrying out the present invention will be described with reference to the drawings. The present invention is not limited to each embodiment, and components can be modified and embodied without departing from the spirit of the present invention. Further, various inventions can be formed by appropriately combining a plurality of components disclosed in each embodiment. For example, some components may be removed from all of the components shown in the embodiments. Furthermore, the components of different embodiments may be optionally combined.

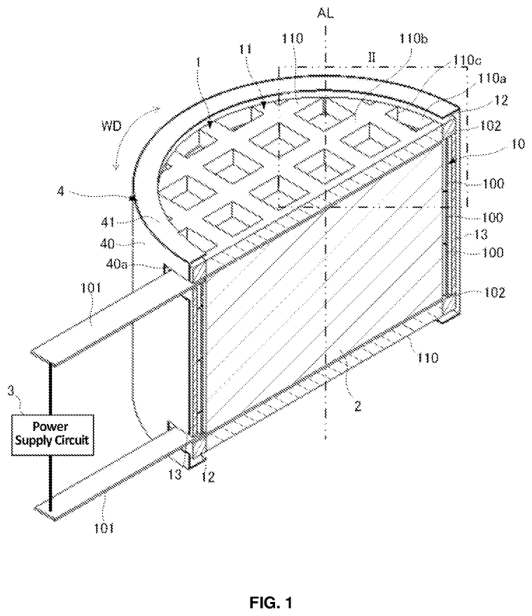

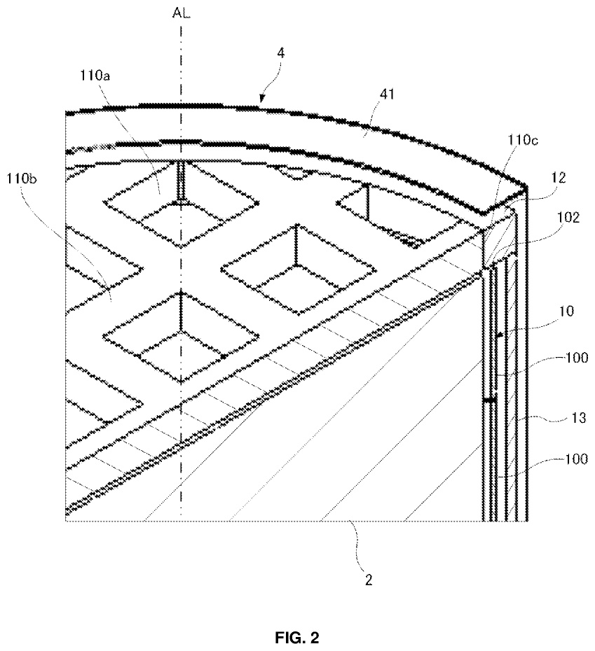

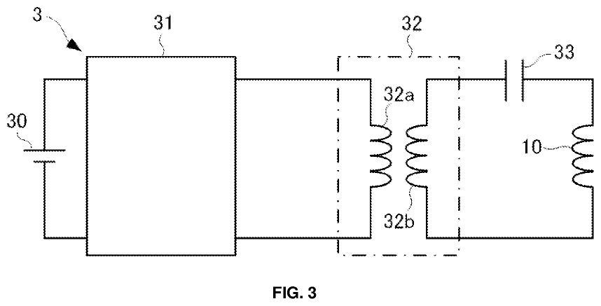

FIG. 1 is a perspective sectional view showing an induction heating device according to an embodiment of the present invention, FIG. 2 is an enlarged perspective cross-sectional view of the region II in FIG. 1, and FIG. 3 is a circuit diagram showing an example of a power supply circuit 3 in FIG. 1. FIG. 1 shows the induction heating device cut in half along a plane including an axis line AL.

The induction heating device shown in FIGS. 1 and 2 is a device configured to be able to heat a heating object 2 by induction heating. The induction heating device according to this embodiment includes: an induction heating coil unit 1; the heating object 2; a power supply circuit 3; and a can 4.

The induction heating coil unit 1 includes: an induction heating coil 10; and a member 11.

The induction heating coil 10 is formed by winding a conductor 100 around a predetermined axis line AL. FIGS. 1 and 2 show an embodiment where a sheet-shaped conductor 100 in which a thickness in a direction orthogonal to the axis line AL is thinner than a width in the extending direction of the axis line AL is wound along a cylinder. However, the shape of the conductor 100 is not limited to the illustrated embodiment, and the conductors 100 having other shapes such as a rectangular or square cross section and a circular cross section may be used. The direction orthogonal to the axis line AL may be synonymous with a radial direction or a width direction of the induction heating coil 10 or the heating object 2. The cross section of the conductor 100 may be solid or hollow (tubular). Further, the winding manner of the conductor 100 is not limited to the illustrated manner, and the conductor 100 may be wound along other shape such as a rectangular tube.

The power supply circuit 3 is connected to the induction heating coil 10 via leader wires 101. By supplying alternating current from the power supply circuit 3 to the induction heating coil 10, a magnetic flux is generated near the induction heating coil 10.

The power supply circuit 3 can have the configuration shown in FIG. 3, although not limited thereto. As shown in FIG. 3, the power supply circuit 3 can include a direct-current power supply 30; an inverter 31; a transformer 32; and a resonance capacitor 33. The direct-current power from the direct-current power supply 30 is converted into alternating-current power by the inverter 31. The transformer 32 has a primary coil 32a connected to the inverter 31 and a secondary coil 32b connected to the resonance capacitor 33 and to the induction heating coil 10. A ratio of the numbers of turns for the primary coil 32a and the secondary coil 32b is N:1. The symbol N is a number greater than 1, and the transformer 32 can amplify the current of the alternating-current power. The capacity of the resonance capacitor 33 is set so as to adjust the resonance frequency of the power supply circuit 3. The induction heating coil 10 can be connected in series to the resonance capacitor 33. The series connected body of the induction heating coil 10 and the resonance capacitor 33 may be connected to both ends of the secondary coil 32b.

The member 11 includes a soft magnetic material 110 disposed at or on an outer side of each of axial end portions 102 of the induction heating coil 10 in the extending direction of the axis line AL. FIGS. 1 and 2 show an embodiment where the member 11 is disposed on the outer side of each of the axial end portions 102 of the induction heating coil 10 in the extending direction of the axis line AL. However, as described above, the member 11 may be disposed at the same position as that of each of the axial end portions 102 of the induction heating coil 10 in the extending direction of the axis line AL. Also, FIG. 1 and FIG. 2 show an embodiment where the member 11 is disposed at both ends of the induction heating coil 10 in the extending direction of the axis line AL. However, the member 11 may be disposed only at one end of the induction heating coil 10.

The heating object 2 is a member intended to be heated by induction heating. The heating object 2 can include a magnetic material and/or a conductive material. The magnetic material and/or the conductive material may form the whole or a part of the heating object 2. The heating object 2 has any shape, and may have a pillar shape as shown in FIG. 1. The pillar shape is understandable as a three-dimensional shape having a predetermined thickness in an axial direction. A ratio (aspect ratio) between an axial length of the heating object 2 and a diameter or width of an end face of the heating object 2 is arbitrary. The pillar shape may also include a shape in which the axial length of the heating object 2 is shorter than the diameter or width of the end face (flat shape). The heating object 2 has any cross-sectional shape, and may have a circular shape as shown in FIGS. 1 and 2, or may have other shapes such as polygons. The axial direction of the heating object 2 may be parallel to the axis line AL, and the central axis of the heating object 2 may be coaxial with the axis line AL.

The heating object 2 is disposed inside the induction heating coil 10 and the member 11. The induction heating coil 10 is located on an outer periphery of the heating object 2, and the member 11 is located on an outer side of the end portion of the heating object 2. The heating object 2 is configured to be heatable by induction heating with a magnetic flux from the induction heating coil 10 when the alternating current is supplied to the induction heating coil 10 from the power supply circuit 3.

Here, the magnetic flux from the induction heating coil 10 tends to concentrate on the outer peripheral portion of the heating object 2 near the induction heating coil 10, and tends to generate a temperature deviation between the outer peripheral portion and the central portion of the heating object 2. However, the induction heating device according to this embodiment is provided with the member 11 including the soft magnetic material 110 disposed as described above. The member 11 (more particularly, the soft magnetic material 110) guides the magnetic flux from the induction heating coil 10 from the conductor 100 side to the axis line AL in a direction orthogonal to the axis line AL. This can prevent the magnetic flux from the induction heating coil 10 from concentrating on the outer peripheral portion of the heating object 2, so that the temperature deviation between the outer peripheral portion and the central portion of the heating object 2 can be reduced. The member 11 including the soft magnetic material 110 is particularly useful for a large-diameter heating object 2 (for example, a heating object 2 having a radius of 60 mm or more) in which the temperature deviation between the outer peripheral portion and the central portion tends to be larger. The member 11 may be referred to as a magnetic flux induction member or the like, from a functional viewpoint.

The can 4 surrounds the induction heating coil unit 1 and the heating object 2 from the outside. The can 4 includes: an outer peripheral wall 40 disposed around the outer periphery of the induction heating coil unit 1 and the heating object 2 in the direction orthogonal to the axis line AL; and an end wall 41 extending from an end portion of the outer peripheral wall 40 in the axis line AL to an inner side in the direction orthogonal to the axis line AL. The outer peripheral wall 40 is provided with an opening portion 40a for drawing out the leader wires 101. The end wall 41 extends so as to cover at least the induction heating coil 10 when the induction heating device is viewed along the axis line AL. The tip of the end wall 41 may be disposed at the same position as the outer edge of the heating object 2 in the direction orthogonal to the axis line AL.

The heating object 2 can form a fluid flow path that flows in the extending direction of the axis line AL. The heating object 2 may be a honeycomb structure, and the fluid may be an exhaust gas, as described below, although not limited thereto.

The member 11 may form a flow path together with the heating object 2 by having a plate-shaped soft magnetic material 110 having a plurality of through holes 110a. Each through hole 110a may be a space or a gap that allows a fluid to flow in the extending direction of the axis line AL. The through holes 110a may be edged by the soft magnetic material 110, or may be spaces or gaps between the soft magnetic materials 110 arranged apart from each other and between the soft magnetic material 110 and the surrounding member. The illustrated soft magnetic material 110 has a plurality of linear portions 110b arranged in the form of grid or net, and a plurality of through holes 110a arranged between the linear portions 110b. The plurality of through holes 110a are spaced apart from each other in a first direction and a second direction that are orthogonal to each other in a plane orthogonal to the axis line AL, and each has a rectangular outer shape when viewed along the axis line AL. The axis line AL extends in the thickness direction of the soft magnetic material 110.

The soft magnetic material 110 can be supported by any structure. In the illustrated embodiment, the soft magnetic material 110 is supported by connection of an outer end 110c to the end wall portion 12. However, it may be supported by other members such as the can 4 or the heating object 2, for example. Further, when the soft magnetic material 110 is disposed at the axial end portions 102 of the induction heating coil 10, a method such as integrally molding of the induction heating coil 10 and the soft magnetic material 110 using a resin may be used.

A maximum width of the through hole 110a in the plane orthogonal to the axis line AL may be 85% or less of the length of the induction heating coil 10 in the extending direction of the axis line AL. When the through hole 110a is rectangular as illustrated, the maximum width of the through hole 110a may be the length of the diagonal line of the through hole 110a. The maximum width of the through hole 110a is 85% or less of the length of the induction heating coil 10, so that the magnetic flux can be guided to the central portion of the heating object 2.

The induction heating coil 10 has opening portions on both sides in the extending direction of the axis line AL. Each of the opening portions may be a space bordered with the axial end portion 102 of the induction heating coil 10. In the embodiment shown in FIGS. 1 and 2, each of the opening portions may be a circular space. The heating object 2 can be inserted into the induction heating coil 10 through the opening portions. The member 11 is arranged to cover at least a part of at least one opening. The illustrated member 11 (soft magnetic material 110) is formed into a disk shape as a whole, and is arranged so as to cover the entire opening portion. In other words, when viewed along the axis line AL, the member 11 overlaps with the entire opening portion of the induction heating coil 10. In the illustrated embodiment, the width of the member 11 in the direction orthogonal to the axis line AL (the diameter of the member 11) is substantially equal to the width of the opening portion (the diameter of the opening portion) in the same direction. For example, it may be understood that when the width of the member 11 is 90% to 110% of the width of the opening portion, they are substantially equal to each other. The member 11 may be arranged coaxially with the opening portion. The width of the member 11 may be larger or less than the width of the opening portion. When the width of the member 11 is less than the width of the opening portion, the member 11 covers only a part of the opening portion. At this time, the member 11 may be arranged coaxially with the opening portion, or may be arranged at an offset position. The member 11 may have a different outer shape than the opening portion.

As described above, the member 11 of this embodiment is arranged at both ends of the induction heating coil 10. The member 11 that covers one opening portion of the induction heating coil 10 can be referred to as a first member, and the member 11 that covers the other opening portion of the induction heating coil can be referred to as a second member.

The induction heating coil unit 1 may have at least one of end wall portions 12 and a back wall 13 surrounding the induction heating coil 10. The end wall portions 12 are arranged to cover at least a part of the axial end portions 102 on both sides of the induction heating coil 10 in the axial direction. The back wall 13 is arranged to cover at least a part of a back portion of the induction heating coil 10. The back portion is a side portion (outer peripheral surface) on the side away from the heating object 2 among the pair of side portions of the induction heating coil 10 in the direction orthogonal to the axis line AL. In the illustrated embodiment, the end wall portions 12 are formed by an annular member, and the back wall 13 is formed by a cylindrical member disposed between the end wall portions 12. The axial end of the back wall 13 may be contacted with or connected to the end wall portions 12.

The end wall portions 12 and the back wall portion 13 may be made of a magnetic material. The magnetic material may be a soft magnetic material. The end wall portions 12 made of the magnetic material are disposed so as to cover at least a part of the axial end portions 102 on both sides of the induction heating coil 10 in the axial direction, so that the magnetic flux of the induction heating coil 10 can be attracted to the end wall portions 12, the concentration of the magnetic flux at the axial end portions 102 of the induction heating coil 10 can be suppressed, and extreme heat generation of the induction heating coil 10 at the axial end portions 102 can be suppressed. Further, the back wall portion 13 made of the magnetic material is disposed so as to cover at least a part of the back portion of the induction heating coil 10, so that the heat generation of the induction heating coil 10 at the back portion can be suppressed.

An outer end 110c of the soft magnetic material 110 is preferably arranged so that a gap between it and the end wall portion 12 is as small as possible, and more preferably, the outer end 110c is arranged in contact with the end wall portions 12. This is because the magnetic flux from the outside can be more certainly guided to the inner side.

The back wall portion 13 may be connected to the member 11 at the end portion of the induction heating coil 10. In this embodiment, the outer end 110c of the soft magnetic material 110 is in contact with the inner edges of the end wall portions 12, and the back wall 13 is connected to the member 11 through the end wall portions 12. The end wall portions 12 and the back wall portion 13 may have functions of connecting members for connecting the member 11 (first member) disposed on one end side of the induction heating coil 10 to the member 11 (second member) disposed on the other end side of the induction heating coil 10.

The soft magnetic material 110 of the member 11 preferably has a relative magnetic permeability (a ratio of a magnetic permeability p of the soft magnetic material 110 to a vacuum magnetic permeability μ₀) of 80 or more. When the relative magnetic permeability is 80 or more, the soft magnetic material 110 can more reliably induce the magnetic flux of the induction heating coil 10 from the conductor 100 side to the axis line AL, so that the temperature deviation between the outer peripheral portion and the central portion of the heating object 2 can be more reliably reduced. The upper limit of the relative magnetic permeability of the soft magnetic material 110 is not particularly limited from the viewpoint of the induction of the magnetic flux, but the upper limit of 10,000 is a standard from the viewpoint of industrial use.

The soft magnetic material 110 preferably has a resistivity of 10 Ωcm or more. When the resistivity is 10 Ωcm or more, the loss in the soft magnetic material 110 can be reduced, and the temperature deviation between the outer peripheral portion and the central portion of the heating object 2 can be more reliably reduced. The upper limit of the resistivity of the soft magnetic material 110 is not particularly limited from the viewpoint of the reduction of the loss, but the upper limit of 10¹⁰ Ωcm is a standard from the viewpoint of industrial use.

The soft magnetic material 110 preferably has a Curie point of 250° C. or more. The Curie point of 250° C. or more can achieve the induction of the magnetic flux in the soft magnetic material 110 even at elevated temperatures, so that the temperature deviation between the outer peripheral portion and the central portion of the heating object 2 can be more reliably reduced. This configuration is particularly useful for embodiments where the soft magnetic material 110 is exposed to the flow of a high temperature gas (an exhaust gas from an internal combustion engine) as described below. In particular, it is preferable that the Curie point of the soft magnetic material 110 disposed on the upstream side in the flow direction of the high temperature gas is 250° C. or more.

The soft magnetic material 110 may be made of a material, including, but limited to, ferrite, Sendust, carbonyl iron, and the like.

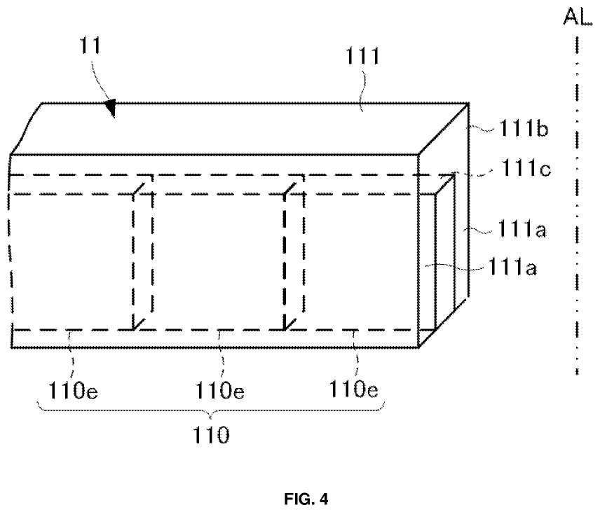

Referring now to FIG. 4, it is a perspective view showing a first variation of the soft magnetic material 110 in FIG. 1. The soft magnetic material 110 of the member 11 may have a solid structure as shown in FIGS. 1, 2, and 3, but it may also have the structure as shown in FIG. 4. That is, as shown in FIG. 4, the soft magnetic material 110 may include a plurality of soft magnetic material blocks 110e arranged side by side in the direction orthogonal to the axis line AL. Further, the member 11 may further include a support material 111 for supporting the plurality of soft magnetic material blocks 110e. The embodiment that uses the soft magnetic material blocks 110e and the support material 111 is particularly useful when the mechanical strength of the material making up the soft magnetic material 110 is lower and it is difficult to form any elongated soft magnetic material 110.

The soft magnetic material blocks 110e are preferably adjacent to each other. It is preferable that each of the soft magnetic material blocks 110e satisfies the above numerical ranges of the relative magnetic permeability and the like. The plate-shaped soft magnetic material 110 may be formed by arranging a plurality of soft magnetic material blocks 110e side by side. In the figure, each of the soft magnetic material blocks 110e is shown to be a rectangular parallelepiped, but the shape of each soft magnetic material block 110e is optional. Multiple types of soft magnetic material blocks 110e having different shapes may be used.

The support member 111 may be a member having a U-shaped cross section, which includes: a pair of side walls 111a; and an end wall 111b connecting one end of the side walls 111a. The support member 111 has a groove 111c defined by the side walls 111a and the end wall 111b, and the soft magnetic material blocks 110e can be disposed in the groove 111c. In the extending direction of the axis line AL, the end wall 111b may be disposed on the side away from the heating object 2, and the surface of the soft magnetic material block 110e exposed from the opening of the groove 111c may be opposed to the heating object 2. In the direction orthogonal to the axis line AL (the longitudinal direction of the support member 111), both ends of the groove 111c may be opened, and the soft magnetic material blocks 110e may be exposed from the opening. For example, the support material 111 and the soft magnetic material blocks 110e are integrated through a heat-resistant sealant (not shown) such as a silicone, a fluorine-based organic resin, or an alumina silicate-based inorganic adhesive.

The material for the support material 111 can be selected from various viewpoints, such as whether or not it interferes with the function of inducing the magnetic flux of the soft magnetic material blocks 110e in view of mechanical strength and electrical conductivity. Examples of the material for the support material 111 that can be used herein include metals such as SUS 430.

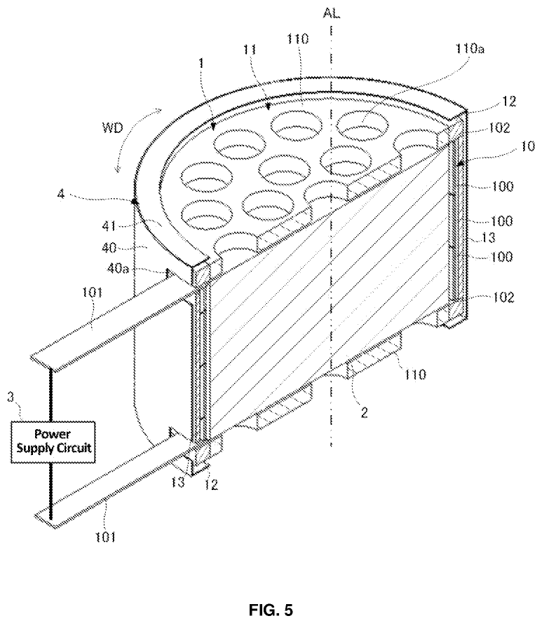

Next, FIG. 5 is a perspective cross-sectional view showing a second variation of the soft magnetic material 110 in FIG. 1. The shape and arrangement of each through hole 110a can be optionally changed. As shown in FIG. 5, each of the through holes 110a may have a circular shape. The through holes 110a may be arranged at a position (central position) through which the axis line AL passes and/or along a plurality of concentric circles having different diameters from one another. The central position of the concentric circles may be a position through which the axis line AL passes. Others are the same as above.

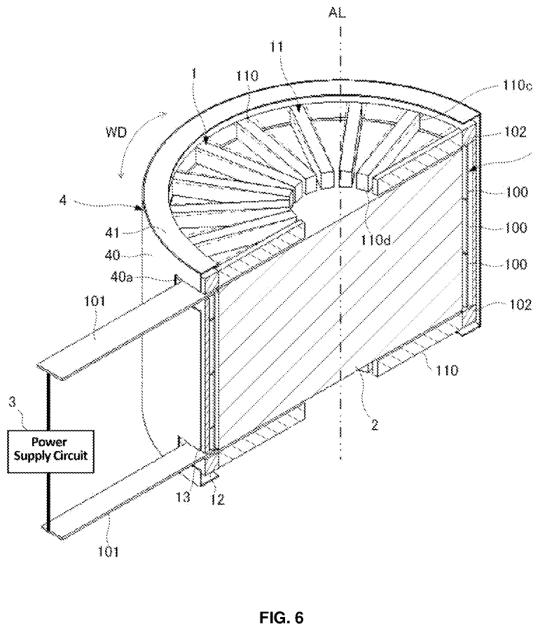

Next, FIG. 6 is a perspective cross-sectional view showing a third variation of the soft magnetic material 110 in FIG. 1. As shown in FIG. 6, the member 11 may include a plurality of rod-shaped soft magnetic materials 110 each extending from the outer edge to the central portion of the opening portion of the induction heating coil 10. FIG. 6 shows an embodiment where a plurality of soft magnetic materials 110 are radially arranged. In other words, each of the plurality of soft magnetic materials 110 extends from the conductor 100 side to the axis line AL in the direction orthogonal to the axis line AL while being spaced apart from each other in a winding direction WD of the conductor 100.

The members 11 (i.e., the soft magnetic materials 110) extend from the conductor 100 side to the axis line AL in the direction orthogonal to the axis line AL. The members 11 may not reach the axis line AL as in the embodiment shown in FIG. 6, or the members 11 may reach the axis line AL. In other words, inner ends 110d of the soft magnetic materials 110 may be not be in contact with each other as shown, or may be in contact with each other. Furthermore, the inner ends 110d of the soft magnetic materials 110 may be connected to each other by another member. The member for connecting the inner ends 110d may have a shape of, for example, an annular body, and may be made of a soft magnetic material.

Each of the plurality of rod-shaped soft magnetic materials 110 has an outer end 110c located on the outer edge side of the opening portion of the induction heating coil 10, and an inner end 110d located on the central side of the opening portion. The cross-sectional area of the outer end 110c may be larger than that of the inner end 110d. That is, as shown by the dashed lines in FIG. 6, each of the soft magnetic materials 110 may be formed to be wider on the outer end 110c side than on the inner end 110d side. Since the outer end 110c side is wider, the magnetic flux can be more reliably induced.

The maximum distance between the plurality of rod-shaped soft magnetic materials 110 is preferably 85% or less of the length of the induction heating coil 10 in the extending direction of the axis line AL. When the soft magnetic materials 110 are radially arranged as shown in the figure, the maximum distance may be a distance between the outer ends 110c of the soft magnetic materials 110 adjacent in the winding direction WD. When the outer end 110c of each soft magnetic material 110 is at the same position as the outer edge of the heating object 2 or radially outward of the outer edge of the heating object 2, the maximum distance between the soft magnetic materials 110 may be regarded as rθ (r×θ), in which r (m) is a radius of the heating object 2, θ (rad) is an angle interval between the soft magnetic materials 110. The maximum distance between the soft magnetic materials 110 of 85% or less of the length of the induction heating coil 10 allows the magnetic flux to be induced to the central portion of the heating object 2. Others are the same as above.

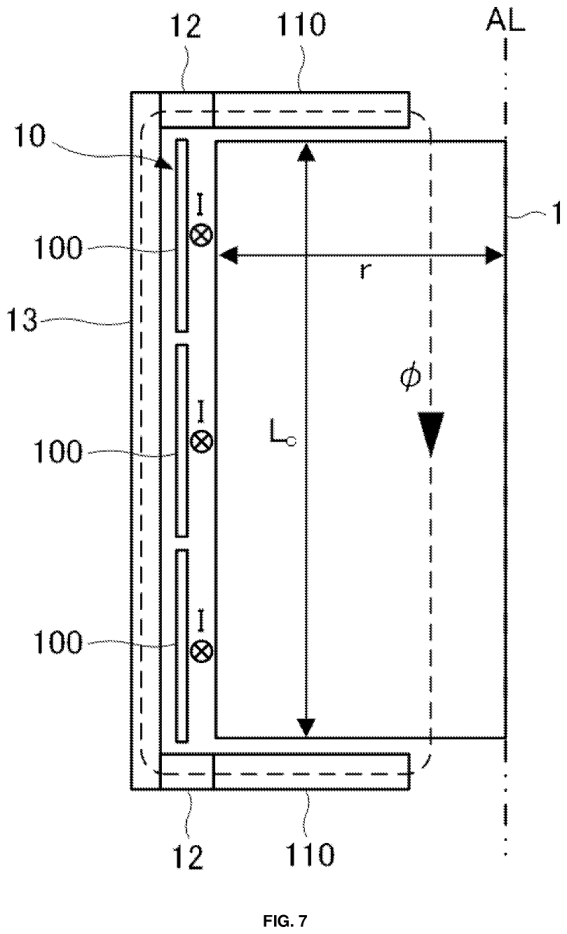

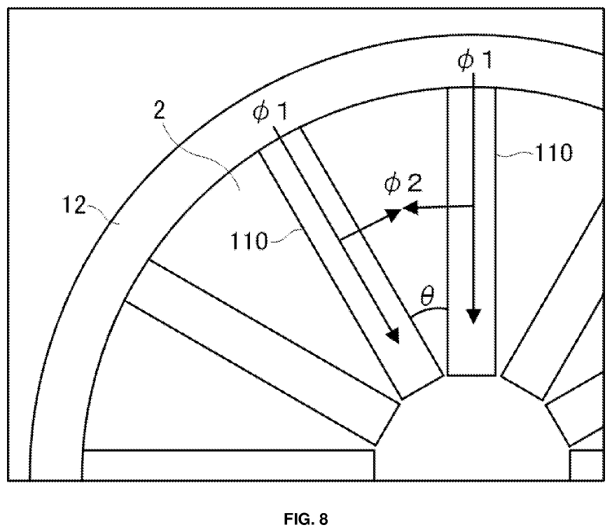

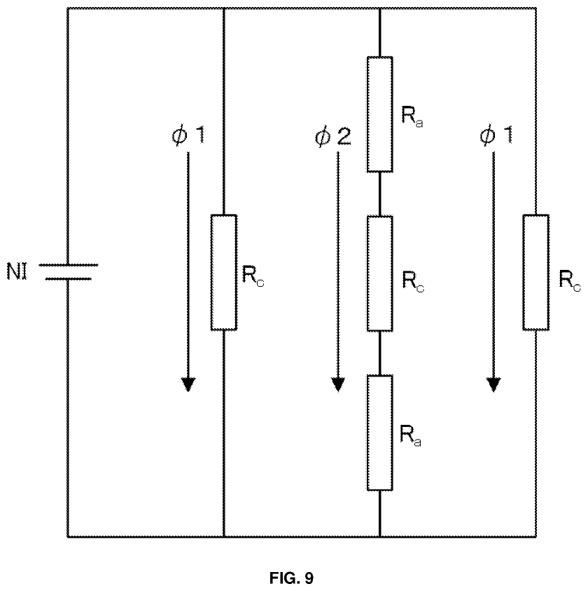

Next, FIG. 7 is a cross-sectional view of the induction heating device shown in FIG. 6, FIG. 8 is a plane view showing the induction heating device shown in FIG. 7, and FIG. 9 is a circuit diagram showing a magnetic circuit through which a magnetic flux φ in FIG. 7 flows. It should be noted that FIG. 7 shows a state where the induction heating device is cut in half along a plane including the axis line AL. Further, the can 4 is omitted in FIGS. 7 and 8.

When the induction heating device is viewed in the cross section as shown in FIG. 7, the magnetic flux φ from the induction heating coil 10 passes through the end wall portions 12 and the back wall portion 13 (connecting members), the member 11 (soft magnetic materials 110) (first member) disposed at one end, the heating object 2, and the member 11 disposed at the other end (second member). On the other hand, when the induction heating device is viewed in plane as shown in FIG. 8, the magnetic flux φ passes not only through the soft magnetic materials 110 of the member 11 but also through the heating object 2 between the soft magnetic materials 110. The magnetic flux φ includes a first magnetic flux φ1 passing through the soft magnetic materials 110 and a second magnetic flux φ2 passing through the heating object 2 between the soft magnetic materials 110.

The flow of such a magnetic flux φ can be represented by a magnetic circuit shown in FIG. 9. Magnetic resistances R_{c} of the heating object 2 are provided in the path of the first magnetic flux φ1. On the other hand, in addition to the magnetic resistances R_{c} of the heating object 2, magnetic resistances Rₐ of the air is provided in the path of the second magnetic flux φ2. The magnetic resistance R_{c} of the heating object 2 can be expressed using a length Lc (m) of the induction heating coil 10 in the extending direction of the axis line AL as a variable. The magnetic resistance Rₐ of the air can be expressed using a distance between the soft magnetic materials 110 as a variable. In particular, when the soft magnetic materials 110 are radially arranged, the distance between the soft magnetic materials 110 can be expressed using the radius r (m) of the heating object 2 and the angle interval θ (rad) between the soft magnetic materials 110 as variables. As described above, the maximum distance between the soft magnetic materials 110 may be regarded as rθ (r×θ). In addition, since the end wall portions 12, the back wall portion 13, and the member 11 have sufficiently large magnetic permeability, the magnetic resistance of the end wall portions 12, the back wall portion 13, and the member 11 is regarded as zero.

As described above, since there is a difference in magnetic resistance between the path of the first magnetic flux φ1 and the path of the second magnetic flux φ2, a difference in an amount of heating due to the magnetic flux φ (square value of the magnetic field caused by the magnetic flux φ) is generated between a portion directly below the soft magnetic material 110 and the soft magnetic material 110. Specifically, the amount of heating between the soft magnetic materials 110 tends to be decreased, as compared to that directly below the soft magnetic materials 110.

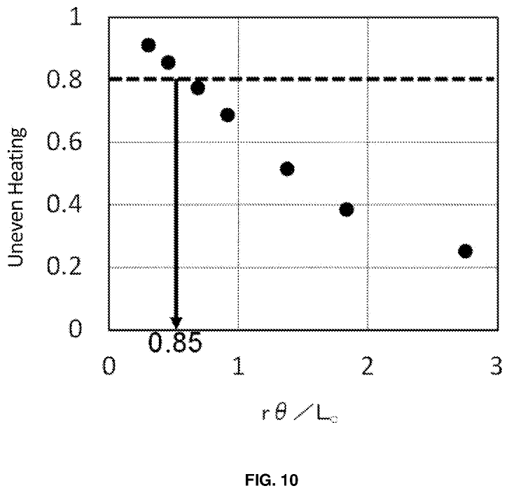

FIG. 10 is a graph showing a relationship between a ratio (rθ/L_{c}) of the maximum distance rθ of the soft magnetic materials 110 to the length L_{c} of the induction heating coil 10 and the uneven heating of the heating object 2. The horizontal axis in FIG. 10 is the ratio (rθ/L_{c}) of the maximum distance rθ between the soft magnetic materials 110 to the length L_{c} of the induction heating coil 10. The vertical axis in FIG. 10 is the uneven heating of the heating object 2, and the uneven heating means a ratio (H2/H1) of an amount of heating H2 at a position where there is no soft magnetic material 110 to an amount of heating H1 at a position directly below the soft magnetic material 110.

In the figure, the plots of black circles represent the relationship between the ratio rθ/L_{c} and the uneven heating when the maximum distance rθ between the soft magnetic materials 110 is changed while maintaining a constant length L_{c} of the induction heating coil 10. As shown in FIG. 10, as the ratio rθ/L_{c} is smaller, the uneven heating is closer to 1. That is, the difference between the amount of heating H1 at the position directly below the soft magnetic material 110 and the amount of heating H2 at the position where the soft magnetic material 110 is not present decreases as the ratio rθ/L_{c} is smaller. When the ratio rθ/Lc is 0.85 or less (i.e., when the maximum distance rθ between the soft magnetic materials 110 is 85% or less of the length L_{c} of the induction heating coil 10 in the extending direction of the axis line AL), the uneven heating can be suppressed to 20% or less. It is, therefore, preferable that the maximum distance rθ between the soft magnetic materials 110 is 85% or less of the length L_{c} of the induction heating coil 10 (rθ/Lc≤0.85). This is true for not only the case where the soft magnetic materials 110 are radially arranged as shown in FIG. 6, but also the case where the soft magnetic material 110 is in the plate shape having a plurality of through holes 110a as shown in FIGS. 1 and 5. When the soft magnetic material 110 is in the plate shape, the maximum width of each through hole 110a (diagonal line of each through hole 110a) is preferably 85% or less of the length L_{c} of the induction heating coil 10.

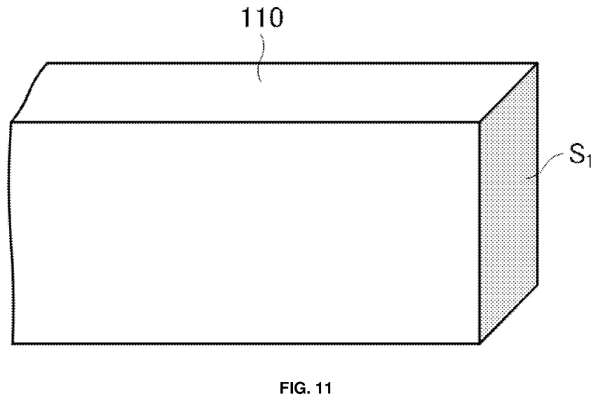

Next, FIG. 11 is a perspective view showing the soft magnetic material 110 in FIG. 7. A suitable range of the total cross-sectional area Sₘ (m²) of the soft magnetic material 110 included in the member 11 will be described with reference to FIGS. 7 and 11.

First, assuming that the magnetic field inside the heating object 2 is uniform, the Ampere's law can be applied to the path of the magnetic flux φ in FIG. 7 to derive a relationship expressed by the following equation (1):

NI=H_{c}L_{c}+Hₘ+H_{w} Equation (1)

in which N is a number of turns of the induction heating coil 10, I (A) is a current flowing through the induction heating coil 10, H_{c} (T) is a magnetic field inside the heating object 2, L_{c} (m) is a length of the heating object 2 in the extending direction of the axis line AL, Hₘ (T) is a magnetic field inside the soft magnetic material 110 included in the member 11, and H_{w} (T) is a magnetic field inside the end wall portions 12 and the back wall portion 13.

Since the magnetic permeabilities of the soft magnetic material 110, the end wall portions 12, and the back wall portion 13 are sufficiently high, the Hₘ and H_{w} can be approximated to zero. Therefore, the following equation (2) can be obtained from the Equation (1):

NI=H_{c}L_{c} Equation (2)

The magnetic flux φ flowing through the heating object 2 can be expressed by the following equation (3) from a relationship between a magnetic flux density and a magnetic field (B=μH):

φ=BS_{c}=μ_{c}H_{c}πr² Equation (3)

in which μ_{c} (H/m) is a magnetic permeability of the heating object 2, S_{c} and πr² (m²) are a cross-sectional area of the heating object 2, and r (m) is a radius of the heating object 2.

From the Equations (2) and (3), the following Equation (4) can be obtained:

φ=(μ_{c}NIπr²)/L_{c} Equation (4)

The magnetic flux φ expressed by the Equation (4) also flows to the soft magnetic material 110 included in the member 11.

Therefore, the magnetic flux density Bₘ of the soft magnetic material 110 included in the member 11 can be expressed by the following Equation (5):

Bₘ=(μ_{c}NIπr²)/L_{c}Sₘ Equation (5)

in which Sₘ (m²) is the total cross-sectional area of the soft magnetic material 110 included in the member 11. When a plurality of soft magnetic materials 110 are provided, the cross-sectional area S₁ (m²) of one soft magnetic material 110 shown in FIG. 11 can be multiplied by a number n of the soft magnetic materials 110 to calculate Sm (=S₁×n). The cross-sectional area S₁ of the soft magnetic material 110 may be an area of an end face of the soft magnetic material 110.

The total cross-sectional area Sₘ of the soft magnetic material 110 is preferably set so that Bₘ in the Equation (5) does not exceed the saturation magnetic flux density Bₘₛ (T) of the soft magnetic material 110, i.e., so that {(μ_{c}NIS_{c})/L_{c} Sₘ}<Bₘₛ is satisfied. By thus setting the total cross-sectional area Sₘ, it is possible to avoid any magnetic saturation in the soft magnetic material 110 included in the member 11.

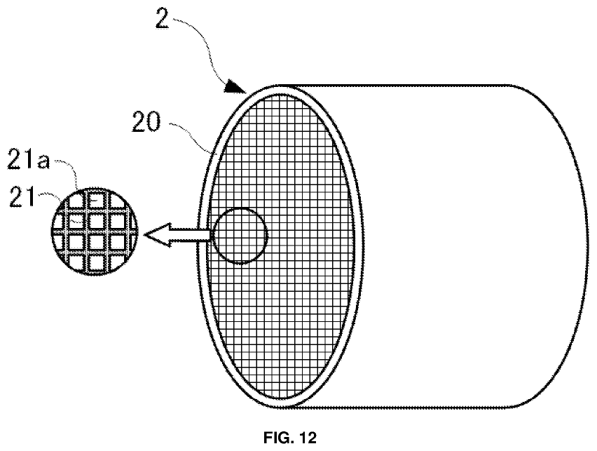

Next, FIG. 12 is a perspective view showing an example of the heating object 2 in FIG. 1. As shown in FIG. 12, the heating object 2 may be a honeycomb structure having a honeycomb structure portion including: an outer peripheral wall 20; and a partition wall 21 disposed on an inner side of the outer peripheral wall 20, the partition wall 21 defining a plurality of cells 21a each extending from one end face to the other end face to form a flow path. When the heating object 2 is the honeycomb structure, the axial direction of the heating object 2 may be the extending direction of the cells 21a. The honeycomb structure may be, for example, a catalyst support that supports a catalyst for purifying an exhaust gas from a vehicle or the like.

The materials of the outer peripheral wall 20 and the partition wall 21 are not limited, but they are typically formed of ceramic materials. Examples of the ceramics include cordierite, silicon carbide, aluminum titanate, silicon nitride, mullite, alumina, silicon-silicon carbide-based composite materials, silicon carbide-cordierite-based composite materials, especially a sintered body mainly based on silicon-silicon carbide composite material or silicon carbide. As used herein, “silicon carbide-based” means that the outer peripheral wall 20 and the partition wall 21 contain 50% by mass of silicon carbide based on the total of the outer peripheral wall 20 and the partition wall 21. The phrase “the outer peripheral wall 20 and the partition wall 21 are mainly based on silicon-silicon carbide composite material” means that the outer peripheral wall 20 and the partition wall 21 contain 90% by mass of more of silicon-silicon carbide composite material (total mass) based on the total of the outer peripheral wall 20 and the partition wall 21. Here, for the silicon-silicon carbide composite material, it contains silicon carbide particles as an aggregate and silicon as a binding material to bind the silicon carbide particles, and preferably a plurality of silicon carbide particles are bound by silicon such that pores are formed between the silicon carbide particles. The phrase “the outer peripheral wall 20 and the partition wall 21 are mainly based on silicon carbide” means that the outer peripheral wall 20 and the partition wall 21 contain 90% or more of silicon carbide (total mass) based on the total of the outer peripheral wall 20 and the partition wall 21.

Preferably, the outer peripheral wall 20 and the partition wall 21 are made of at least one ceramic material selected from the group consisting of cordierite, silicon carbide, aluminum titanate, silicon nitride, mullite, and alumina.

The cell shape of the honeycomb structure is not particularly limited, but it may preferably be polygonal such as triangular, quadrangular, pentagonal, hexagonal, and octagonal, circular, or oval, in the cross section orthogonal to the central axis of honeycomb structure, or it may be irregularly shaped. Preferably, it is polygonal.

The thickness of the partition wall 21 of the honeycomb structure is preferably 0.05 to 0.50 mm, and more preferably 0.10 to 0.45 mm, in terms of ease of production. For example, when it is 0.05 mm or more, the strength of the honeycomb structure can be further improved, and when it is 0.50 mm or less, pressure loss can be reduced. The thickness of the partition wall 21 is an average value measured by microscopic observation of the cross section in the central axis direction.

The partition wall 21 preferably have a porosity of 20 to 70%. The porosity of the partition wall 21 is preferably 20% or more in terms of ease of production, and when it is 70% or less, the strength of the honeycomb structure can be maintained.

The partition wall 21 preferably have an average pore diameter of 2 to 30 μm, and more preferably 5 to 25 μm. The average pore diameter of the partition wall 21 of 2 μm or more leads to easy production, and the average pore diameter of 30 μm or less allows the strength of the honeycomb structure to be maintained. As used herein, the terms “average pore diameter” and “porosity” mean an average pore diameter and porosity measured by mercury intrusion technique.

The cell density of the honeycomb structure is not particularly limited, but it may preferably be in the range of 5 to 150 cells/cm², and more preferably in the range of 5 to 100 cells/cm², and even more preferably in the range of 31 to 80 cells/cm².

The outer shape of the honeycomb structure may be, but not limited to, a pillar shape having circular end faces (cylindrical shape), a pillar shape having oval end faces, and a pillar shape having polygonal (rectangular, pentagonal, hexagonal, heptagonal, octagonal, etc.) end faces.

The honeycomb structure is produced by forming a green body containing ceramic raw materials into a honeycomb shape having a partition wall extending from one end face to the other to form a plurality of cells that serve as fluid flow paths to form a honeycomb formed body, and then firing the honeycomb formed body after drying it. When the resulting honeycomb structure is used for the honeycomb structure, the outer peripheral wall may be extruded integrally with the honeycomb structure and used as it is as the outer peripheral wall, or the outer periphery of the honeycomb structure may be ground to a predetermined shape after forming or firing, and the honeycomb structure from which the outer periphery has been ground is coated with a coating material to form an outer peripheral coating. In this embodiment, for example, the honeycomb structure with the outer periphery may be used without grinding the outermost periphery of the honeycomb structure, and the outer peripheral surface of the honeycomb structure with that outer periphery (i.e., further outer side of the outer periphery of the honeycomb structure) may be further coated with the above coating material to form an outer peripheral coating. The former case will result in an outer peripheral wall in which only the outer peripheral coating comprised of the coating material is located in the outermost periphery for the outer peripheral surface of the honeycomb structure. On the other hand, the latter case will result in formation of a two-layered outer peripheral wall which is located in the outermost periphery and in which the outer peripheral coating consisting of the coating material is further laminated onto the outer peripheral surface of the honeycomb structure. The outer peripheral wall may be extruded integrally with the honeycomb structure portion and fired as it is, and may be used as the outer peripheral wall without any processing of the outer periphery.

The honeycomb structure is not limited to an integrated honeycomb structure with which the partition wall 21 is integrally formed. It may be, for example, a honeycomb structure (joined honeycomb structure) having a structure where a plurality of pillar shaped honeycomb segments each having a ceramic partition wall and a plurality of cells defined by the partition wall to form fluid flow paths are combined via joining material layers.

A part or the whole of the honeycomb structure may include a magnetic material. The embodiment where the honeycomb structure has the magnetic material is arbitrary. For example, the magnetic material may be included in: (1) a coating layer provided on the surface of at least one of the outer peripheral wall 20 and the partition wall 21; (2) plugged portions that plug the cells 21a on at least one and other end faces of the honeycomb structure; (3) a structure filled in the cells 21a; and/or (4) an annular body embedded in a groove provided on at least one and other end faces of the honeycomb structure.

As the magnetic material, for example, a plate-shaped, rod-shaped, ring-shaped, wire-shaped or fibrous magnetic material can be used. In the present invention, the rod-shaped magnetic material and the wire-shaped magnetic material are classified into a rod-shaped magnetic material if the diameter of the cross section perpendicular to the length direction is 0.8 mm or more, and a wire-shaped magnetic material if it is less than 0.8 mm.

When filling the cells 21a with the magnetic material or when plugging the cells 21a, the magnetic materials having those shapes can be used as appropriate depending on the shape of the cells 21a. A plurality of magnetic materials may be collectively filled in one cell 21a, or only one magnetic material may be filled in one cell 21a.

When the magnetic material is provided as the coating layer, the coating layer includes a fixing material in which powder of the magnetic material is dispersed. The fixing material that can be used herein includes glass, crystallized glass and ceramics, which contain silicate, borate or borosilicate, or glass, crystallized glass and ceramics, which contain other oxides, and the like.

When the magnetic material is provided as a filling material, the magnetic material may be arranged in every other cell to form a staggered pattern with respect to the vertically and horizontally adjacent cells 21a, or may be arranged in every other two or more cells, such as in every other two cells or three cells, or may be continuously arranged. The number, arrangement, and the like of the cells 21a filled with the filling material of the magnetic material are not limited, and they can be appropriately designed as necessary. From the viewpoint of increasing the heating effect, it is preferable to increase the number of cells 21a filled with the filling material of the magnetic material, whereas from the viewpoint of reducing pressure loss, it is preferable to reduce the number as much as possible.

The filling material may be composed of a composition in which the magnetic material and a binding material or an adhesive material are combined. Examples of the binding material include materials based on a metal or glass. The adhesive material includes materials based on silica or alumina. In addition to the binding material or adhesive material, it may further contain an organic or inorganic substance. The filling material may be filled from one end face to the other end face over the entire honeycomb structure. Further, the filling material may be filled from one end face of the honeycomb structure to the middle of the cells 21a.

The types of the magnetic material are, for example, the balance Co—20% by mass of Fe; the balance Co—25% by mass of Ni—4% by mass of Fe; the balance Fe—15 to 35% by mass of Co; the balance Fe—17 Co—2% by mass of Cr—1% by mass of Mo; the balance Fe—49% by mass of Co—2% by mass of V; the balance Fe—18% by mass of Co—10% by mass of Cr—2% by mass of Mo—1% by mass of Al; the balance Fe—27% by mass of Co—1% by mass of Nb; the balance Fe—20% by mass of Co—1% by mass of Cr—2% by mass of V; the balance Fe—35% by mass of Co—1% by mass of Cr; pure cobalt; pure iron; electromagnetic soft iron; the balance Fe—0.1 to 0.5% by mass of Mn; the balance Fe—3% by mass of Si; the balance Fe—6.5% by mass of Si; the balance Fe—18% by mass of Cr; the balance Fe—16% by mass of Cr—8% by mass of Al; the balance Ni—13% by mass of Fe—5.3% by mass of Mo; the balance Fe—45% by mass of Ni; the balance Fe—10% by mass of Si—5% by mass of Al; the balance Fe—36% by mass of Ni; the balance Fe—45% by mass of Ni; the balance Fe—35% by mass of Cr; the balance Fe—13% by mass of Cr—2% by mass of Si; the balance Fe—20% by mass of Cr—2% by mass of Si—2% by mass of Mo; the balance Fe—20% by mass of Co—1% by mass of V; the balance Fe—13% by mass of Cr—2% by mass of Si; the balance Fe—17% by mass of Co—2% by mass of Cr—1% by mass of Mo, and the like.

While the preferred embodiments of the present invention have been described above in detail with reference to the drawings, the present invention is not limited to such embodiments. It is obvious that one of ordinary skill in the art to which the present invention belongs can arrive at various variations or modifications in the scope of the technical idea recited in the claims, and they are also understood to belong to the technical scope of the present invention.

### DESCRIPTION OF REFERENCE NUMERALS

10: induction heating coil
100: conductor
102: axial end portion
11: member
110: soft magnetic material
110e: soft magnetic material block
111: support material
2: heating object

1. An induction heating device, comprising:
an induction heating coil with a conductor wound around a predetermined axis line;
a member comprising at least one soft magnetic material, the at least one soft magnetic material being disposed at or on an outer side of each of axial end portions of the induction heating coil in an extending direction of the axis line; and
a heating object disposed on an inner side of the induction heating coil and the member, the heating object being configured to be heatable by induction heating using a magnetic flux from the induction heating coil.

2. The induction heating device according to claim 1, wherein the heating object forms a flow path for a fluid flowing in the extending direction of the axis line.

3. The induction heating device according to claim 2, wherein the member has a plate-shaped soft magnetic material having a plurality of through holes to form a flow path together with the heating object.

4. The induction heating device according to claim 3, wherein a maximum width of the through hole in a plane orthogonal to the axis line is 85% or less of a length of the induction heating coil in the extending direction of the axis line.

5. The induction heating device according to claim 1,
wherein the induction heating coil has opening portions on both sides in the extending direction of the axis line, and
wherein the member is disposed so as to cover at least a part of at least one of the opening portions.

6. The induction heating device according to claim 1,
wherein the induction heating coil has opening portions on both sides in the extending direction of the axis line, and
wherein the member comprises: a first member covering one opening portion of the induction heating coil; and a second member covering other opening portion of the induction heating coil.

7. The induction heating device according to claim 1, further comprising a back wall disposed to cover at least a part of a back portion of the induction heating coil, the back wall being made of a soft magnetic material.

8. The induction heating device according to claim 7, wherein the back wall is connected to the member at an end portion of the induction heating coil.

9. The induction heating device according to claim 1,
wherein the induction heating coil has opening portions on both sides in the extending direction of the axis line, and
wherein the member comprises a plurality of rod-shaped soft magnetic materials each extending from an outer edge of each of the opening portions to a central portion.

10. The induction heating device according to claim 9,
wherein each of the rod-shaped soft magnetic materials has an outer end located on the outer edge side of each of the opening portions, and an inner end located on the central portion side of each of the opening portion, and
wherein a cross-sectional area of the outer end is larger than that of the inner end.

11. The induction heating device according to claim 9, wherein a maximum distance between the rod-shaped soft magnetic materials is 85% or less of the length of the induction heating coil in the extending direction of the axis line.

12. The induction heating device according to claim 1, wherein the soft magnetic material has a relative magnetic permeability of 80 or more.

13. The induction heating device according to claim 1, wherein the soft magnetic material has a resistivity of 10 Ωcm or more.

14. The induction heating device according to claim 1, wherein the soft magnetic material has a Curie point of 250° C. or more.

15. The induction heating device according to claim 1,
wherein the soft magnetic material has a plurality of soft magnetic material blocks arranged side by side in a direction orthogonal to the axis line, and
wherein the member further comprises a support material for supporting the plurality of soft magnetic material blocks.

16. The induction heating device according to claim 1, wherein a total cross-sectional area Sₘ of the soft magnetic material is set to satisfy {(μ_{c}NIS_{c})/L_{c}Sₘ}<Bₘₛ, wherein μ_{c} (H/m) is a magnetic permeability of the heating object, N is a number of turns of the induction heating coil, I (A) is a current flowing through the induction heating coil, S_{c} (m²) is a cross-sectional area of the heating object, L_{c} (m) is a length of the heating object in the extending direction of the axis line, Sₘ (m²) is a total cross-sectional area of the soft magnetic material included in the member, and Bₘₛ (T) is a saturation magnetic flux density of the soft magnetic material.

17. The induction heating device according to claim 1, wherein the heating object is a honeycomb structure having a honeycomb structure portion comprising: an outer peripheral wall and a partition wall disposed on an inner side of the outer peripheral wall, the partition wall defining a plurality of cells, each of the cells extending from one end face to other end face to form a flow path.

18. The induction heating device according to claim 17, wherein a part or the whole of the honeycomb structure comprises a magnetic material.

19. The induction heating device according to claim 1, further comprising a power supply circuit, the power supply circuit comprising:
a direct-current power supply;
an inverter for converting direct-current power from the direct-current power supply to alternating-current power; and
a transformer connected to the inverter and the induction heating coil, the transformer amplifying a current of the alternating-current power of the inverter and supplying it to the induction heating coil.
